(19) United States
(12) Patent Application Publication
(10) Pub. No.: US 2016/0063087 A1
(43) Pub. Date: Mar. 3, 2016

(54) METHOD AND SYSTEM FOR PROVIDING LOCATION SCOUTING INFORMATION

(71) Applicants: Kevin BERSON, Sherman Oaks, CA (US); Joesph Christian GAMMILL, Huntingtion Beach, CA (US); Christopher RAMPEY, Bellevue, WA (US); THOMSON LICENSING, Issy de Moulineaux (FR)

(72) Inventors: KEVIN BERSON, SHERMAN OAKS, CA (US); JOESPH CHRISTIAN GAMMILL, HUNTINGTON BEACH, CA (US); CHRISTOPHER RAMPEY, BELLEVUE, WA (US)

(21) Appl. No.: 14/777,362

(22) PCT Filed: Mar. 24, 2014
(86) PCT No.: PCT/US14/31580

§ 371 Date: Sep. 15, 2015

Related U.S. Application Data
(60) Provisional application No. 61/824,937, filed on May 17, 2013.
(60) Provisional application No. 61/824,941, filed on May 17, 2013.

(51) Int. Cl. G06F 17/30; G06F 21/62; G06F 17/24

(52) U.S. Cl. CPC G06F 17/30598; G06F 17/241; G06F 17/30507; G06F 21/6218; G06F 17/30525; G06F 17/30289; G06F 17/3053

(57) ABSTRACT

A location scouting tool (300 and 365) for content creators using multimedia annotations on video production projects. The location scouting tool (300 and 365) may be an aggregation of location annotations created by several authorized content creator (210) based on a set of access rules (215) defined for each content creator, where the access rules limit each content creator's ability to create location annotation (220) within video production projects.

### CROSS-REFERENCE TO RELATED APPLICATIONS

This application claims the benefit of U.S. Provisional Application 61/824,937, entitled “Location Database”, filed May 17, 2013, and U.S. Provisional Application 61/824,941, entitled “Multi-Media Search”, filed May 17, 2013, which are incorporated herein by reference.

### FIELD OF INVENTION

The present disclosure generally relates to the creation of content rich location scouting information and more specifically to providing the ability to search for and obtain highly relevant location scouting information for film, video, and/or television productions.

### BACKGROUND

Currently it is challenging to quickly and easily search for locations used in creative projects because there is no high quality ‘go-to’ source to search and scout locations related to shooting multimedia content (e.g., video, photos, audio) and/or productions projects. Further, once ideal locations are identified it is difficult to know who to contact to secure the location for the project. It is also difficult to get a sense for how good the quality of the location is for any particular video productions. All this results in having to hire costly professional location scouters to help source location options.

The prevalence of on-line video sites do a very good job of serving audio/video content, however there is a much greater story that can be told about the content creation process than merely the final work product showcased on these on-line video sites. For example, content creators have little ability to provide various ‘behind the scenes’ or ‘director's cut’ perspectives on the content to illustrate their technical roles in the content production, details associated with scouting and securing a shooting location, problems that were overcome during the production, inspiration that drove a particular frame, scene, or project, or general information that is unique to the content creator.

Furthermore, online users are regularly limited to text only conversations. Most sites limit the user's ability to include media in their conversations. This inherently and glaringly limits the value of such conversations, especially in relation to advising on locations, scene and/or shot selections, and general shootability for a particular location. Searching for specific types of locations, conversations about the locations, or answers to a user's query (on Google for instance) will return a multitude of results with varying utility. Often it is up to the user to spend inordinate amounts of time sifting the search results and making several calls to find simple, actionable and relevant information.

Usually there are several individuals involved in the content creation process (e.g. directors, producers, actors, writers, editors, make-up artists, sound mixers, set designers, costume designers, lighting crew, location scouters, etc.). Allowing these individuals to comment on their work and provide highly relevant information about particular locations may allow content creators to save time, money, and effort in selecting and securing locations for video shoots.

For these reasons, there exists a need for an integrated solution that allows content creators to exchange ideas in a media rich environment and provide visually rich commentary on work product that will allow content creators to conduct multi-faceted searches for locations that may be suitable for other content productions.

### BRIEF SUMMARY

Some embodiments provide a system and method for creating a detailed repository of locations, where the locations are associated with several attributes describing the location with respect to creating content (e.g., video projects, short films, movies, etc.). Some embodiments may receive multimedia content along with an identification of several content collaborators involved in creating the multimedia content.

The content collaborators may be assigned a set of access rules that define rights for associating location annotations to a piece of content. The content collaborators may annotate the multimedia content with a geographical identification of a location used in creating the content. The content collaborators may further provide detailed location information relevant to the content creation process to be associated with the location annotation.

Some embodiments provide for the creation of a location scouting engine that aggregates location annotations and returns detailed location scouting information gathered from several location annotations. The location scouting engine may provide a location information interface for providing content creators with a comprehensive location scouting tool for use during the content creation process.

The preceding Summary is intended to serve as a brief introduction to some embodiments of the present disclosure. It is not meant to be an introduction or overview of all inventive subject matter disclosed in this document. The Detailed Description that follows and the Drawings (or “Figures” or “FIGS.”) that are referred to in the Detailed Description will further describe some of the embodiments described in the Summary as well as other embodiments. Accordingly, to understand all the embodiments described by this document, a full review of the Summary, Detailed Description and the Drawings is needed.

### BRIEF DESCRIPTION OF THE DRAWINGS

The novel features of the disclosure are set forth throughout this specification. However, for purpose of explanation, some embodiments are set forth in the following drawings.

FIG. 1 illustrates an exemplary system that may be used to implement some embodiments;

FIG. 2 illustrates a flow chart of an exemplary process used by some embodiments;

FIG. 3a illustrates an exemplary graphical user interface of a default view of a location scouting tool according to one embodiment;

FIG. 3b illustrates an exemplary graphical user interface of detailed location information according to one embodiment;

FIG. 4 illustrates a flow chart of an exemplary process used in some embodiments for annotating media with location information and/or attributes;

FIG. 5 illustrates a block diagram of an exemplary system for implementing an application for creating a location scouting system of some embodiments;

FIG. 6 illustrates an exemplary software architecture of a project repository application;

FIG. 7 illustrates a flow chart of a exemplary process used by some embodiments to define and store a location scouting application of some embodiments; and

FIG. 8 illustrates a schematic block diagram of an exemplary computer system with which some embodiments may be implemented.

### DETAILED DESCRIPTION

In the following detailed description, numerous details, examples, and embodiments are set forth and described. However, it will be clear and apparent to one skilled in the art that the disclosure is not limited to the embodiments set forth, and that the disclosed embodiments may be practiced without some of the specific details and examples discussed.

Several more detailed embodiments are described in the sections below. Section I provides a description of an exemplary system and methods that may be used in some embodiments of the present disclosure to create a location scouting repository for content creators. Section II describes a video player of some embodiments. Section III describes different implementations of multimedia annotations in some embodiments. Section IV describes a system and software architecture used in some embodiments. Lastly, Section V describes a computer system which implements some of the embodiments of the present disclosure.

### I. System Overview

While most platforms limit search to text only or, perhaps, one kind of media (video but not audio or documents) the present system will, from the outset, allow all users to use the richness of media options (video, sounds, document uploads, images, and even simple text) to participate. User can post any of the various media types on the platform and then, in other aspects of the site, have lively conversations also with the ability to use the multitude of rich media options (posting questions or answers that allow for these media types). Using this richness of media, the platform is able to supply the users, upon their query, real-time media-rich search results based upon keyword and meta tag queries.

Some embodiments of the present disclosure provide a platform for a user-base that is an active and aware community keenly interested in getting the most relevant, up-to-date and distilled answers to highly-technical, situational and cutting edge questions. Some embodiments provide a system that is an integrated solution for content creators/collaborators (e.g. directors, producers, actors, writers, editors, make-up artists, sound mixers, set designers, costume designers, lighting crew, location scouters, etc.) to network with other content creators, exchange ideas in a media rich environment, and provide visually rich commentary on work product. The intent is to supply acutely relevant, highly informative and media-rich answers that allow the user base to communicate in the richest possible way. For example, some of the rich commentary may include specific details about locations used to produce particular scenes in a production.

This platform may allow for deeper conversations between content creators, content curators and the broader industry and fan communities by providing the stakeholders to tell ‘behind the scenes’ stories and/or share relevant materials with each other. Such conversations provide an insight to the rich process of content creation, as told from multiple perspectives. For example, a director might post a picture of a hotel that inspired the setting of a scene is his film or the director may provide details of the locations used and positive and negative aspects about those locations.

These perspectives may take the form of visual annotations to work product, which may be content from an ongoing project or a final video production. The visual annotations may be multimedia objects that could be one or a combination of text, audio, video, PDF files or images that may be visually attached on a video timeline of the content, for example.

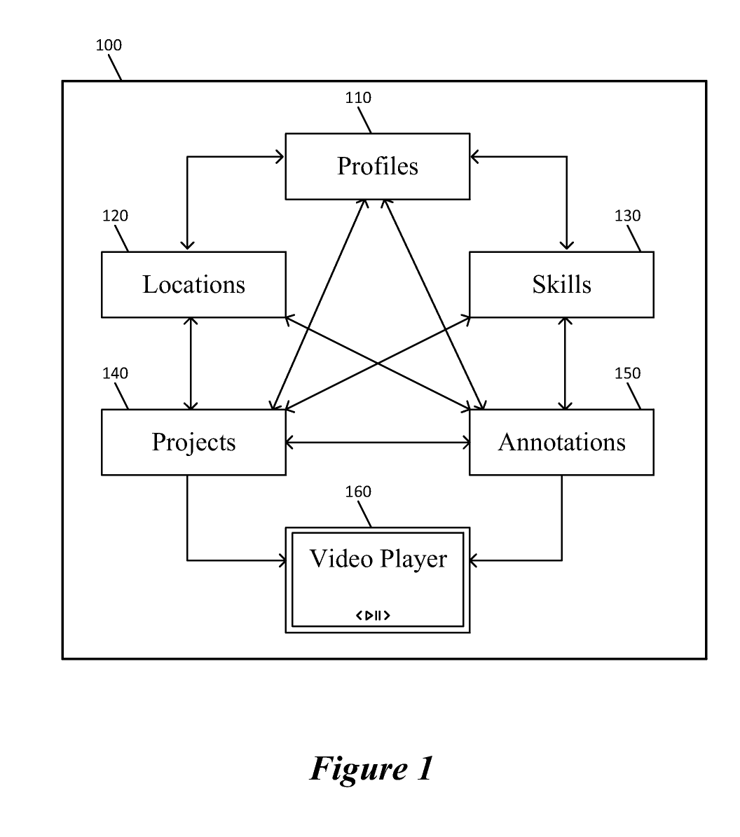

FIG. 1 illustrates an overview of an exemplary system 100 that may be used to implement some embodiments of the present disclosure. The system 100 may include several different interconnected databases including databases for user profiles 110, locations 120, skills 130, work product or projects 140, annotations 150, and a video player 160.

The profiles database 110 include all the profiles that content creators create in the system 100. These profiles can grow over time with annotations made on projects as well as locations and skills used while working on those projects.

The locations database 120 may include several locations identified by content creators that were used during particular shoots. These locations may be linked to projects, multimedia annotations, and/or profiles. Each location in the locations database 120 may also be filled with several types of metadata, tags, and/or attributes of the locations, and other relevant information that may be used by any content creator on the platform while searching for locations to use in a video and/or photography production. For example, the locations may be tagged with geographical identifiers such as zip codes, city, country, etc. as well as location types (e.g., office, home, stadium, church, jail, library, etc.) for easy filtering during a location scouting session. Other relevant information may include availability information, location contact information, images, or any relevant information regarding the capturing of different types of content used in a video production. The system may aggregate several details about locations over time to produce a media rich and detailed repository of locations. The systems and methods by which locations can be identified, attached to content, and scrutinized will be explained in greater detail below.

The skill database 130 may be a database of different skills content creators use in the course of the content creation process. This may not necessarily be related to intangible skills, and could also include the different types of gear/equipment (e.g., cameras, rigs, lighting) or hardware/software that is used during the content creation process. These skills may be linked to annotations on a project which may in turn populate into a content creator's profile to illustrate the level of expertise and use of different skills and/or equipment/gear/software/etc. used during the content creation process. Skills could also include certain types of visual styles and aesthetics that the creator has expertise in e.g. film noir, western, surreal, etc.

The projects database 140 may include all the various types of content uploaded to the system. Throughout this detailed description, projects may be used interchangeably with the terms content, production, video, photography, animation, video game or any combination thereof. Each project may also be associated with several verified content creators. Some of these content creators may have active profiles in the system while others may not. A content creator may be verified as a contributor to the project via a curator in charge of managing content in the system, through a third party such as a studio or verified online database of content creators and their respective work, via a listing of credits from the content itself, by verification provided by a pre-defined number of peers, by the content owner or any other means to verify that the content creator contributed to the production of that content. Once a content creator has been associated as a verified contributor to the content, he or she may contribute to that content by adding rich commentary using multimedia annotations.

Each project in the database 140 may be linked to several profiles (i.e. content creators who worked on that project), locations used to produce the content, skills/equipment used in to shoot the production, as well as all the annotations associated with that project.

The annotations database 150 includes all the multimedia annotations made in the system in association with a project. After creating an annotation the content creator may also be prompted to add tags or associations to the annotation such as location or skills relevant to the particular annotation. The creation and types of annotations that can be created and viewed alongside video production projects in the video player 106 will be discussed in greater detail in Section II.

One of ordinary skills in the art will recognize that the system 100 may be implemented in various different ways without departing from the scope of the disclosure. For instance, some of the databases may be implemented as a single database. In addition, one of ordinary skill in the art will recognize that several other databases or modules may also be incorporated into the system without departing from the scope of the present disclosure. For example, the system may also be further enriched by including a question and answer database related to projects, equipment reviews, general content creation methodologies, a job board, as well as a database of companies that may provide a wide array of services that are needed during the content creation process (e.g. post production, catering, recruiting, etc.). One of ordinary skill will understand that this type of information may easily be included into the system 100 and have linked interconnections with the other several modules or databases within the system 100.

Generally, limiting search queries to overly broad results or limiting conversations and content to just video or text ultimately limits the information available to the end user. Therefore, to achieve highly relevant search results with the system 100, the system 100 may intentionally limit the user base it is attracting and how that user base can interact with the system. The entire platform may be aimed at a culture of dynamic content creators, for example, professionals and aspiring professionals who are highly active in both the creation and consumption of rich media content. This limited, yet active, user base may allow for inherently refined search results by limiting at the outset what content is actually hosted and curated on the platform.

As content/projects are uploaded to the system, there may be several criteria that will regulate who and how the content may to be annotated. For example, the owner of the content (e.g. a film production studio) will own intellectual property rights to the content and may not wish for the content to be readily available to the general public or even generally available to the content creators that contributed to the creation of the movie production. The platform may have restrictions imposed by the owner or curator of the content to prohibit the viewing of the production in its entirety and therefore limit the amount of time or amount of scenes which may be annotated within the production as a whole or limit the amount of time a content creator may annotate the content, among other limitations. In some cases, the content owner or curator may wish to limit annotation rights to a certain sub-set of verified content contributors (e.g., director, producer, lead actor, lead sound technician, etc.) rather than granting access rights to all verified content contributors. Alternatively, there may be instances when the content owner wants to allow all users within the system including the general public to comment and annotate his work.

To control access to the content, the content owner, a designated third party, or a content curator may define access rules to the content and annotation rights for content creators. For example, the content may only be viewable to verified and permitted content contributors in pre-defined increments (e.g., 15 seconds, 30 seconds, 1 minute). Furthermore, access rules may define how permitted content contributors are allowed to annotate the content with multimedia objects. For example, limits may be imposed on the number of annotations allowed by a content creator, the types of annotations (e.g., video, text, images, PDF, etc.), the length of the annotation, or the duration of viewable content in associations with an annotation (i.e. a temporal limit to the portion or particular scene of the media content to be associated with the annotation). The time limit on viewable content/scenes is one exemplary method that may be used so the content owner maintains control of how much of his video production is viewable thereby avoiding unwanted distribution of the content itself, which also allows the focus to be maintained on the content creators and their commentary.

These limits may be imposed automatically based on a content creator's title or reputation within the system 100, the content creator's contribution to the particular production, or the content creators role with respect to the production, among other criteria. The access rules assigned to a content creator for a particular project may be automatically determined by the system based on certain criteria as discussed above or they may be manually assigned by the content owner or curator of the content. In some instances, a content creator may also submit requests to the content owner or curator for initial annotation access, or to increase the amount of access previously defined by the system or content owner/curator.

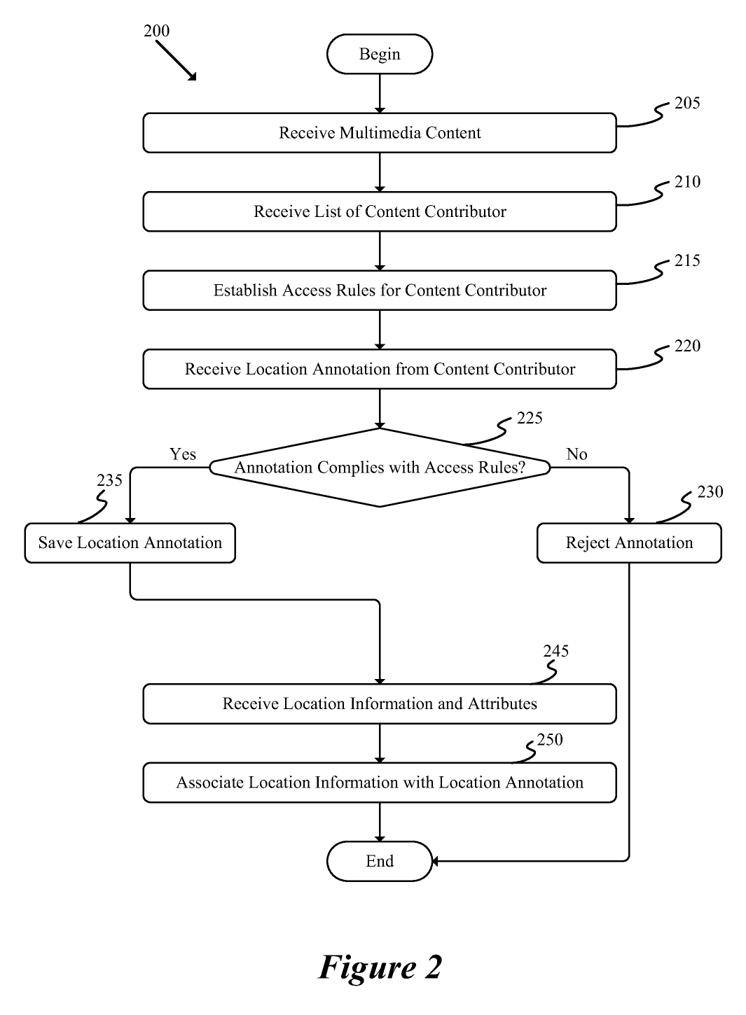

FIG. 2 illustrates a flow chart of an overall process 200 used by some embodiments of the system to associate a location annotation to a particular scene within a piece of content residing on the system. The process 200 begins with the system receiving multimedia content (at 205) such as a movie production or short film. Next, the system may receive (at 210) a list of verified content creators that had a role in the production of the media content received by the system. These content creators may be associated with the content and, in some embodiments of the system, their names may be displayed as contributors when a user views the content as a project stored within the system.

After the content creators have been identified (at 210), a set of access rules may be established (at 215) for each content creator as discussed above. The access rules will determine the scope and type of annotations that each of the content contributors may add to the content. For example, the persons in charge of location scouting for a particular project may be the only persons allowed to annotate a project with location information in the form of multimedia commentary having location information or a standalone location annotation. Then, the content contributors can view the content based on their access rules and the process 200 is ready to receive annotations (at 220) from the content contributors. At this point, a content contributor may be able to define what portion of the content he wants to annotate. In some embodiments, the content contributor may be provided an annotation tool to navigate to a portion of the content's timeline and select a still frame, a length of time, or a beginning and ending time reference that he wishes to associate with his multimedia annotation/commentary.

During the creation of an annotation, the process 200 may check (at 225) to see whether the annotation complies with the access rules defined for the content contributor. For example, in the case of a location annotation, some embodiments may prompt a content contributor to first provide a geographical identifier for the scene location, e.g. city, zip code, state, country, etc. Once a geographical identifier is selected and the user attempts to save the location annotation access rules may be checked to determine whether the user has sufficient rights to provide a location annotation among other access rules.

For example, in some instances only certain content contributors involved in location identification for the project may be allowed to insert a location annotation with respect to a particular scene. If a proper content selection is made by a content contributor having sufficient access rights and all other relevant access rules are satisfied (e.g., the current number of annotation made by the content contributor in the current content), the process 200 may save (at 235) the location annotation. If an annotation is not in compliance with the access rules, the process 200 may reject (at 230) the annotation.

If a location annotation is in compliance with all the access rules assigned to the content contributor, then the content contributor may further provide detailed location information and/or attributes of the location to the location annotation. This information and/or attributes may include several pieces of location relevant data that may later be used to rate or score the location for consideration during a location scouting session for any particular media project.

For example, relevant information for location scouting may include: (i) contact information for securing the location including physical address of the location and contacts, (ii) availability for the location, (iii) cost, (iv) images, (v) location description/type/classification information (e.g. office, school, park, urban, airport, rooftop, etc.) (vi) a shootability rating conveying the overall ease of setting up shots at the location, (vii) information about the type of scene shot at the location (e.g., action, car chase, conversation, stunts, wedding, party, etc.), (viii) permit requirements for film production at the location, (ix) crew conveniences at the location (parking, bathrooms, dining options, etc.) or (x) road accessibility for delivering crew/equipment/trailers/etc. These are just some examples of the type of information that can be populated per location. One skilled in the art would appreciate that this list is not exhaustive and that other relevant information may be included. Such in-depth location details provide content creators and/or a general user of the system the ability to ascertain a location used in a particular scene within a film production and pull great detail about that location which may assist in quickly identifying locations that may be suitable for other unrelated project.

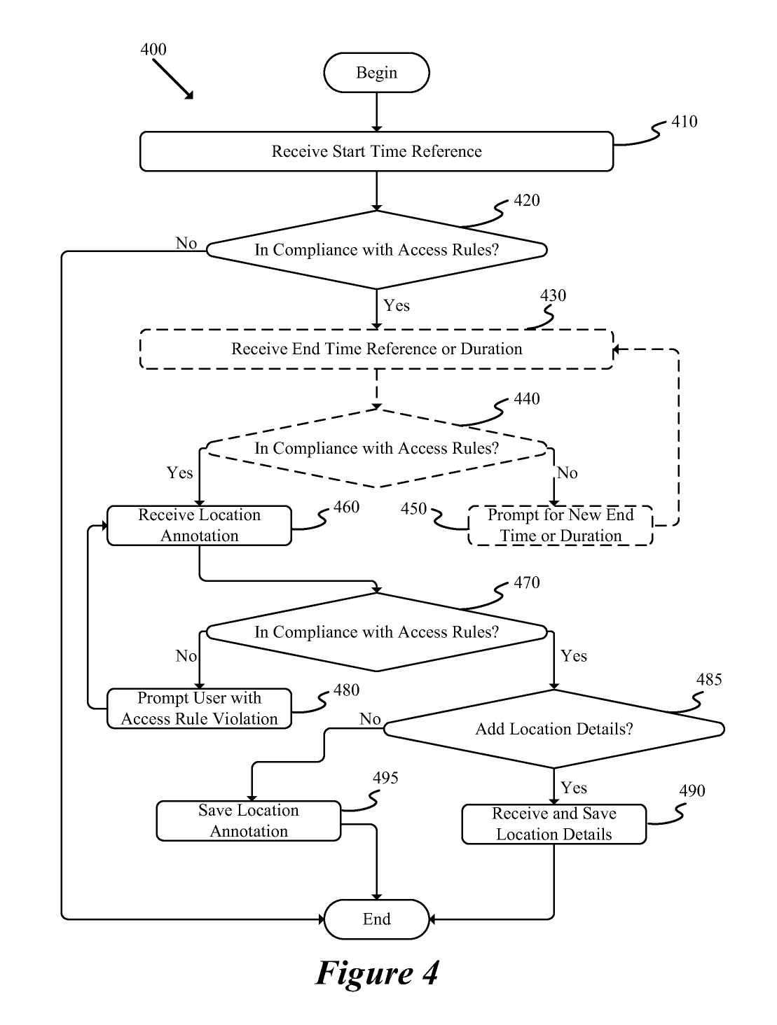

One of ordinary skill in the art will recognize that process 200 may be performed in various appropriate ways without departing from the scope of the disclosure. For instance, the process may not be performed as one continuous series of operations in some embodiments. In addition, the process may be implemented using several sub-processes (e.g. subsequent FIG. 4), or as part of a larger macro-process. Furthermore, various processes may be performed concurrently, sequentially, or some combination of sequentially and concurrently. Moreover, the operations of the process may be performed in different orders.

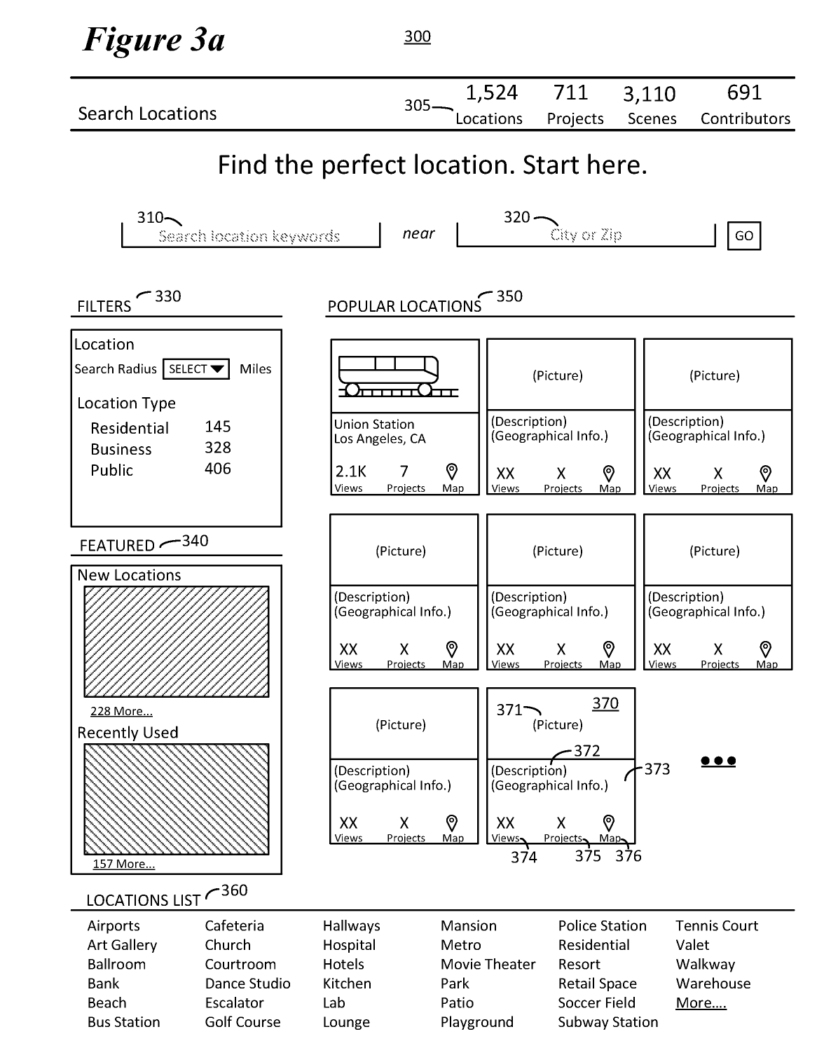

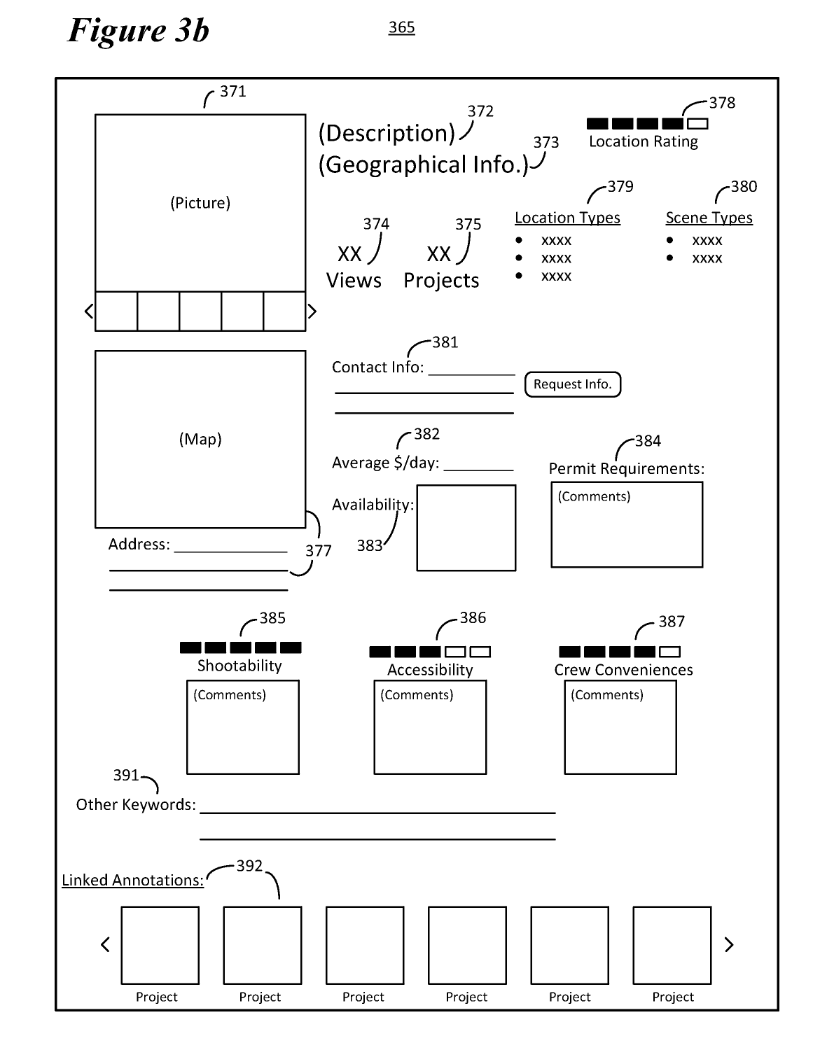

As content creators annotate projects over time with location information for particular scenes, the system 100 is able to create a robust and detailed presentation of locations used during the content creation process for use as a powerful location scouting tool. FIG. 3a illustrates an exemplary graphical user interface (“GUI”) of a location scouting tool created by the system.

The location scouting tool may be initially presented in a default view that allows a user to begin a location scouting session. As illustrated in FIG. 3a the location scouting tool 300 may provide several metrics 305 as the number of locations in the system grows via the content creator community. For example, some system metrics may include the number of locations, number of projects having location annotations, types of locations, number of scenes shot at locations, and number of contributors providing location annotations for the location tool.

A user may be presented with general search capabilities to allow a content creator to start a location scouting session by entering in location keywords 310 (e.g., location type, scene keywords, etc.) along with geographical search criteria 320 (e.g., city, state, zip, country, etc.) which may return several results. The keywords may return matching locations based on keywords and descriptions entered as location information/attributes during the creation of a location annotation and, if the users wishes, the results can further be narrowed down to a geographical area if geographical search criteria is entered. A user can further fine tune search criteria using several filters 330 such as a search radius and/or location type along with any of the several criteria previously mentioned above. New or featured location 340 may also be highlighted in the default search view. Furthermore, popular locations 350 may also be displayed on the default view to spark the creative process as a content creator begins the location scouting process. In addition to this, the user may also be provided a locations list 360 identifying several types of locations within the system. A user may be able to search this list using the keyword search bar 310 or by simply clicking on any location type from the list 360 to return all location grouped under that specific location type. From there, a user can further narrow results using the filters 330.

Location results may be presented in several different layouts. For example, as illustrated in FIG. 3a, each location may be presented as a tile 370 that includes a still picture of the location, the location name/description 372, geographical information 373 to convey where the location is, the number of views 374 within the system for that location, the number of projects/productions 375 the location has been used in, and a map link 376 that may take the user to a map of the location.

FIG. 3b illustrates an exemplary GUI of some embodiments for displaying all the relevant information and/or attributes of a selected location. As illustrated, all the same information from the location tile 370 may be prominently displayed in the location information view 365 including a map with accompanying address information 377. Some embodiments may provide an overall rating 378 for the location with respect to the several criteria that make a location suitable for content productions. The overall rating 378 may be an aggregate weighted score of all the individual user ratings for the location. It would be appreciated that many different algorithms and weighting scales could be used when calculating an overall location rating without departing from the present disclosure. For example, user location ratings may be weighted differently based on the rater's reputation in the system in some embodiments, while other embodiments may present adjusted ratings such that rater's with similar skill sets to the viewer of the location information are weighted higher (e.g., users who are directors, camera crew, etc. receive adjusted ratings based on ratings from similar skill-set users).

Additional location information may include one or more location types 379 identified by the several contributors of the location. The several types of scenes shot 380 at the location may also be displayed to provide the location scout with ideas of how the location has been used in the past during content productions. Other location information may include contact persons and information 381 on how to get in touch with a location manager for securing further information or dates for shooting content at that location. If contact information provided by the community is available, some embodiments may also provide a ‘request information’ tool to contact the location manager without having to exit the system 100. General location information may also include the average cost per day 382, availability 383 (e.g. calendar), and permit requirements 384 for conducting a content production project at the location.

Further user ratings may also be assigned by the authorized community such as shootability 385, accessibility 386, and crew conveniences 387 as previously discussed. The rating for each of these may be accompanied by text descriptions of shooting advantages/disadvantages, accessibility, and crew conveniences as well as pictures, video, and/or audio, which in some instances may be included as part of the location annotation provided by users. General keywords 390 or description that may not fit into another category may also be provided for each location. Finally, each location may include all the linked location annotations 391 so a user can view the several projects the location was used in, any multimedia commentary regarding the location, and any of the attributes that may be described in greater detail via multimedia annotations for the project (i.e. content). The list of linked annotations 391 may also be viewed by clicking the projects link 375 in the tile view or location information view 365.

One of ordinary skill in the art will recognize that the location scouting interfaces 300 add 365 are only examples and that other GUIs may be implemented in various different ways and/or layouts without departing from the scope of the disclosure. For instance, location annotations may be displayed in a list format alphabetically, along a timeline based on project start, completion, or release dates, in numerical order based on the number of annotations per project, or any combination thereof. In addition, one of ordinary skill in the art will recognize that location annotations may be adapted for different uses without departing from the scope of the disclosure. For example, location annotations may be made on behalf of groups of collaborators or for companies working in creative services such as professional location scouters or post production companies.

### II. Video Player

Returning now to FIG. 1, some embodiments of the present disclosure provide a video player 160 adapted for viewing content, creating location annotations to the content, and viewing the annotations in a seamless manner without confusing a viewer. For example, once content is received by the system, a content contributor having sufficient access rights to that content may be able to navigate to any particular place along the content's timeline. From there, a simple annotation tool/control may be invoked to create or view an annotation directly from the timeline.

FIG. 4 illustrates a flow chart of a process 400 used in some embodiments of the present disclosure for creating a location annotation (e.g. step 220 of FIG. 2). The process 400 may begin when the user (i.e. content contributor) invokes the annotation tool at a specified start time in the content. The process 400 receives (at 410) the starting time reference of the content, which in some cases may be a still frame of the content showing a shot of the scene location, and subsequently may check (at 420) that the user has not violated an access rule (e.g., check to see that the user will not exceed the number of allowed annotations for the current content). If the user has violated an access rule, the process 400 may end.

If the user is not selecting a still frame, the process 400 may optionally allow the user to input (at 430) either an end time or duration for the content (e.g., spanning the scene shot at a particular location) that he wishes to call out as a reference to the location annotation he is about to create. If a period of time is selected, the process 400 may then check (at 440) the duration of the content called out against the access rules for the user. If the duration of the content to be viewed in association with the annotation exceeds the access rules defined for the user, the process 400 may prompt the user (at 450) for a new end time or duration length of the content to be called out. In some embodiments, the system may automatically select the duration or change a selected duration without prompting the user based on his access rules. For example, when adding a location annotation, the system may only allow for a still frame to be captured from the beginning of a scene shot at a particular location. If the duration of the content does comply with the user's access rules, the user may proceed with inputting a location annotation, which may begin with a simple entry identifying the location generally by name, location type, or geographical information (e.g., city, state, zip code, country).

After the process 400 receives the initial location annotation (at 460) another check may be made (at 470) to see whether the annotation complies with the user's access rules (e.g., the duration of the annotation if a duration is selected or access rights for contributing locations annotations rather than only general commentary annotations). If an access rules is violated, the user may be prompted (at 480) of the violation and asked to select another annotation type or exit the process. If the location annotation complies with the user's access rules, then the user may be presented with the option to add (at 485) location details in the form of location information or attributes as discussed above. These details may be displayed in the form of a fillable GUI similar to the GUI provided in FIG. 3b. After the user adds details about the location, the location annotation may then be saved (at 490) and associated with the content at the specified time period called out by the user. If the user chooses not to add additional details and only save the general location identification as inputted at 460, the location annotation will be saved (at 495) and the process 400 will end.

One of ordinary skill in the art will recognize that process 400 may be performed in various appropriate ways without departing from the scope of the disclosure. For instance, the process may not be performed as one continuous series of operations in some embodiments. In addition, the process may be implemented using several sub-processes, or as part of a larger macro-process. Furthermore, various processes may be performed concurrently, sequentially, or some combination of sequentially and concurrently. Moreover, the operations of the process may be performed in different orders.

When a typical user is browsing locations on the platform, all the location annotations saved to the content along with corresponding detailed information may be displayed in various ways. For instance, a horizontal timeline spanning the length of the video player may have callouts of where location annotation are present. These callouts may be dots, dashes or other visual cues on the timeline indicating that an annotation is present. In some embodiments, hovering over a callout may also display a still image or text preview of the location annotation. Other embodiments may show a vertical timeline underneath the main video player with each location annotation displayed in a callout box having a preview of the location annotation.

While viewing the content (i.e., a video production/project) on the video player, invoking a location annotation to be displayed or play (e.g. if video or audio annotation) may occur in various ways based on user and/or system preferences. For example, while the user interacts with a location annotation, the video player may automatically pause the content so the user is not confused whether he or she is watching the video or interacting with the annotation, which could also be video. Therefore, when a user clicks on an annotation, the annotation may supersede the primary viewing experience and the main video content may fade out in the background. In some embodiments, the annotation may be displayed as a layer on top of the video player while other embodiments may display the annotation underneath the video player in an annotation window or along the timeline where the annotation is located. Furthermore, some embodiments may play a multimedia annotation while the main content is still being played without sound, that is the audio of a multimedia annotation supersedes the main content's audio but the main video content continues to be played so the viewer can relate the annotation to the content in real time. In some embodiments the playback of the annotation may also be defined by the content creator making the annotation.

Some embodiments of the video player may also provide annotation controls for viewing annotation. For example, the video player may provide the ability to skip from one annotation to the next along the timeline. In addition to traditional fast forward and rewinding on the video timeline for the main content, these annotation controls may allow a user to easily move forward and backwards through the various annotations.

### III. Multimedia Annotations

The multimedia annotation created by content creators in association with projects and video production within the system may take the form of text, video, audio, PDF or photos and may be visually represented along a video timeline in the form of various color coded icons representing the type of annotation or role of content creator telling the story (e.g. editor, set designer, etc.). The annotations may also be commented on by other verified collaborators of the content, peers, the general community on the platform, or public guests viewing the annotations.

The annotations and/or comments attached to an individual annotation may also reference a timecode within the text of an annotation, for example, by appending the ‘at’ symbol (@) to a timecode (e.g., @01:11:03). The timecode reference may linked where clicking on the timecode will automatically start playback of the main content being referenced in the video player.

Furthermore, annotations may also be color coded or assigned icons based on groupings of content contributors/collaborators. For example, the uploader of the content may be represented by a particular color or icon with respect to his or her annotation on the projects page of the uploaded content while the crew is defined by another color or icon. Other groups may include the platform community (e.g. those not associated as collaborators for the specified content), the general public, a curator of the content, film critics, sound technicians, etc.

For example, all location annotations may be displayed in a particular color so all location shots can be quickly identified when viewing a summary of all annotations associated with a project or piece of content.

### IV. System Architecture

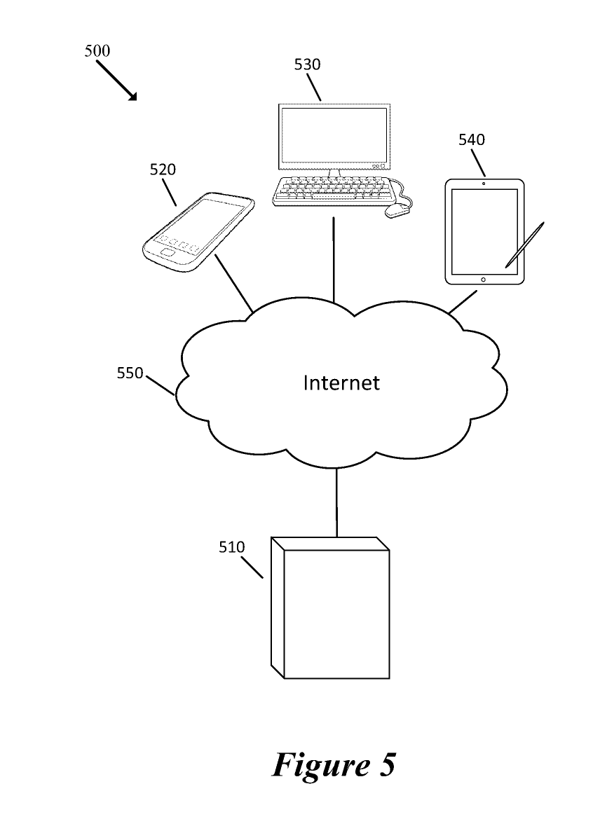

FIG. 5 illustrates an exemplary block diagram of a system 500 for implementing an application that can create a location scouting tool according to some embodiments of the present disclosure. The system 500 includes a server 510 and one or more electronic devices such as smart phones 520, personal computers (PCs) (e.g., desktops or laptops) 530, and tablets 540. The server 520 provides support for the video player as well as hosting for project content and multi-media annotations via the Internet 550. In some embodiments, users may access the video player on the server 520 and provide multi-media annotations using a browser or application on the electronic devices.

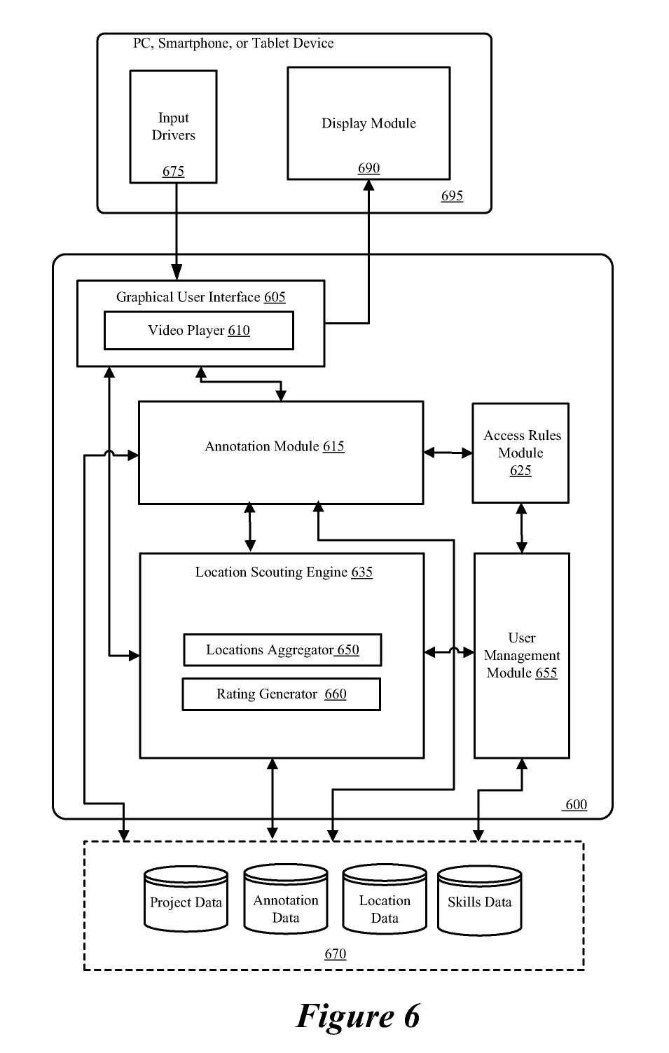

In some embodiments, the above-described operations may be implemented as software running on a particular machine such as a desktop computer, laptop, or handheld device (e.g. smartphone or tablet), or as software stored in a computer readable medium. FIG. 6 illustrates the software architecture of a location scouting application 600 in accordance with some embodiments. In some embodiments, the application is a stand-alone application or is integrated into another application (for instance, application 600 might be a portion of a professional network application), while in other embodiments the application might be implemented within an operating system. Furthermore, in some embodiments, the application is provided as part of a server-based (e.g., web-based) solution. In some such embodiments, the application is provided via a thin client. That is, the application runs on a server while a user interacts with the application via a separate client machine remote from the server (e.g., via a browser on the client machine). In other such embodiments, the application is provided via a thick client. That is, the application is distributed from the server to the client machine and runs on the client machine. In still other embodiments, the components (e.g., engines, modules) illustrated in FIG. 6 are split among multiple applications. For instance, in some embodiments, one application may aggregate data to create a location scouting tool, while another application maintains annotations and project relationships.

As shown in FIG. 6, the application 600 includes a graphical user interface 605, multimedia annotation module 615, access rules module 625, location scouting engine 635, and user management module 655. The graphical user interface 605 may provide a video player 610 having user-interface tools (e.g., display areas, dock controls, etc.) that a user of the application 600 interacts with in order to view content within the system and to create multimedia annotations in association with the media content being viewed in a main display of the video player 610.

As shown in FIG. 6, to facilitate the creation of annotations, the application 600 may include an annotation module 615. In some embodiments, when the user inputs instructions to create annotations to media content, the annotation module 615 may receive and process these instructions in order save and display the annotation in the graphical user interface 605. In addition, the annotation module 615 may send and receive data to and from an access rules module 625 for verifying whether annotations received from a user are in compliance with rules that govern they types and attributes of annotations created by the user.

As shown in FIG. 6, a location scouting engine 635 of some embodiments includes a location aggregator 650 and location rating generator 660 that may be used to communicate with the multimedia annotation module 615, the graphical user interface 605, a user management module 655, and/or a set of data storages 670 (e.g., project data, annotation data, location data, skills data, etc.). The location scouting aggregator 650 may pull location information from all the location annotations in the system and the location scouting engine 635 may then be able to parse through the data and return relevant location information based on specific and pointed search criteria provided by a user scouting for locations to use in a new project. The location rating generator 660 may use that information to calculate an overall rating for the location with respect to shooting content based on all the information and rating provided by the several location annotations.

Electronic devices (e.g., PCs, smartphones, tablets, etc.) 695 used in conjunction with some embodiments include input drivers 675 for allowing the application 600 to receive data from the device so the application 600 can send multimedia content to a display module 690 of the device (e.g., screen or monitor). In some embodiments, the data sent to the device may be sent via a network or over the Internet.

An example operation of the application 600 will now be described by reference to the components (e.g., engines, modules) illustrated in FIG. 6. A user may interact with user-interface tools (e.g., annotation controls) in the graphical user interface 605 of the location scouting application 600 via input drivers 675 of his device 695 (e.g., a mouse, touchpad, touch screen, etc.) and keyboard (e.g., physical keyboard, virtual keyboard, etc.).

When the user interacts with one or more user-selectable elements (e.g., controls, menu items) in the graphical user interface 605, some embodiments translate the user interaction into input data and send this data to the annotation module 615. The annotation module 615 in some embodiments receives the input data and processes the input data in order to create and save annotations to be associated with media content being displayed in the video player 610. For example, when the annotation module 615 receives instructions for creating an annotation associated with a media clip, the annotation module 615 may process the input data by identifying the portion of media content and type of annotation received, for example, and saves the annotation. Furthermore, the annotation module 615 may communicate with the access rules module 625 to ensure that the annotation received from the user does not violate the user's access rules that restrict certain attributes of allowable annotation as described above.

When a user's annotations are saved by the application 600, they can be stored in the set of data storages 670. From the set of data storage 670, the location scouting engine 635 may be able to aggregate several types of location data and display a location information as a search page or search results via the graphical user interface 605. The user management module 655 may communicate with the location scouting engine 635 to ensure only authorized persons are allowed to annotate content with location information to be used by the location scouting application 600.

It should be recognized by one of ordinary skill in the art that any or all of the components of location scouting software 600 may be used in conjunction with the present disclosure. Moreover, one of ordinary skill in the art will appreciate that many other configurations may also be used in conjunction with the present disclosure or components of the present disclosure to achieve the same or similar results.

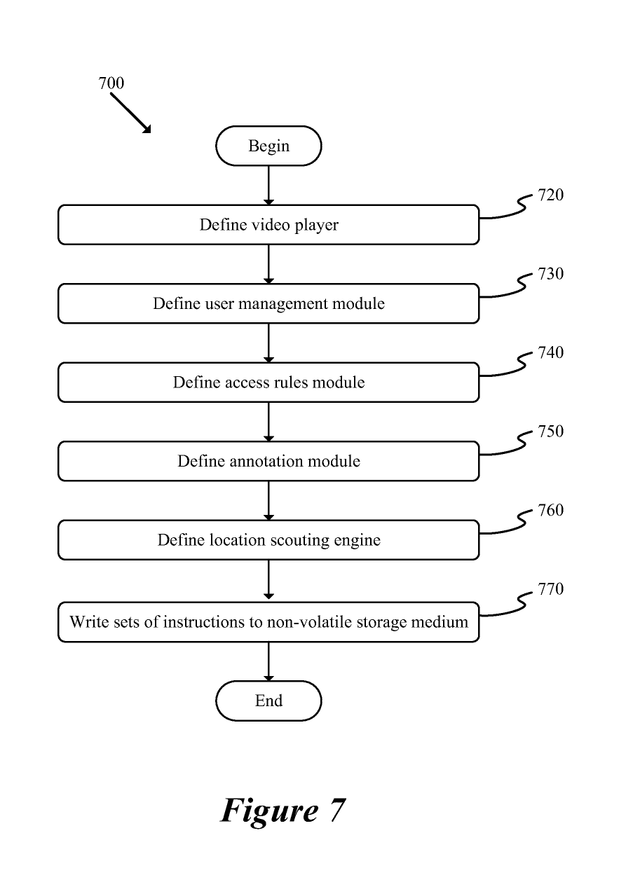

FIG. 7 illustrates a flow chart of a process 700 used by some embodiments to define and store the location scouting application of some embodiments. Specifically, process 700 illustrates the operations used to define sets of instructions for providing several of the elements described above in FIG. 1 and for creating a video player with annotation capabilities, a user management module, defining access rules for content creators, an annotations module, and the location scouting engine. The process 700 may be used to generate a location scouting application of some embodiments.

Process 700 may begin with the generation of a computer program product for use by consumers. As shown, the process may define (at 720) sets of instructions for implementing a video player having annotation capabilities (e.g., as described above in reference to Section II). In some cases such sets of instructions are defined in terms of object-oriented programming code. For example, some embodiments may include sets of instructions for defining classes and instantiating various objects at runtime based on the defined classes.

Next, process 700 defines (at 730) sets of instructions for a user management module (e.g., for managing curators, content creators, general public, etc.). Process 700 then defines (at 740) sets of instructions for defining an access rules module for the content creator. Then process 700 defines (at 750) sets of instructions for implementing an annotations module (e.g., as described above in reference to FIG. 4). The process 700 may then define (at 760) sets of instructions for a location scouting engine (e.g., aggregating users' location annotations in a graphical user interface as described above in reference to FIGS. 3a and 3b). Finally, the process writes (at 770) the sets of instructions to a storage medium such as, but not limited to, a non-volatile storage medium.

One of ordinary skill in the art will recognize that the various sets of instructions defined by process 700 are not exhaustive of the sets of instructions that could be defined and stored on a computer readable storage medium for a location scouting application incorporating some embodiments of the disclosure. In addition, the process 700 is an exemplary process, and the actual implementations may vary. For example, different embodiments may define the various sets of instructions in a different order, may define several sets of instructions in one operation, may decompose the definition of a single set of instructions into multiple operations, etc. In addition, the process 700 may be implemented as several sub-processes or combined with other operations within a macro-process.

### V. Computer System

Many of the processes and modules described above may be implemented as software processes that are specified as at least one set of instructions recorded on a non-transitory storage medium. When these instructions are executed by one or more computational elements (e.g., microprocessors, microcontrollers, Digital Signal Processors (“DSPs”), Application-Specific ICs (“ASICs”), Field Programmable Gate Arrays (“FPGAs”), etc.) the instructions cause the computational element(s) to perform actions specified in the instructions.

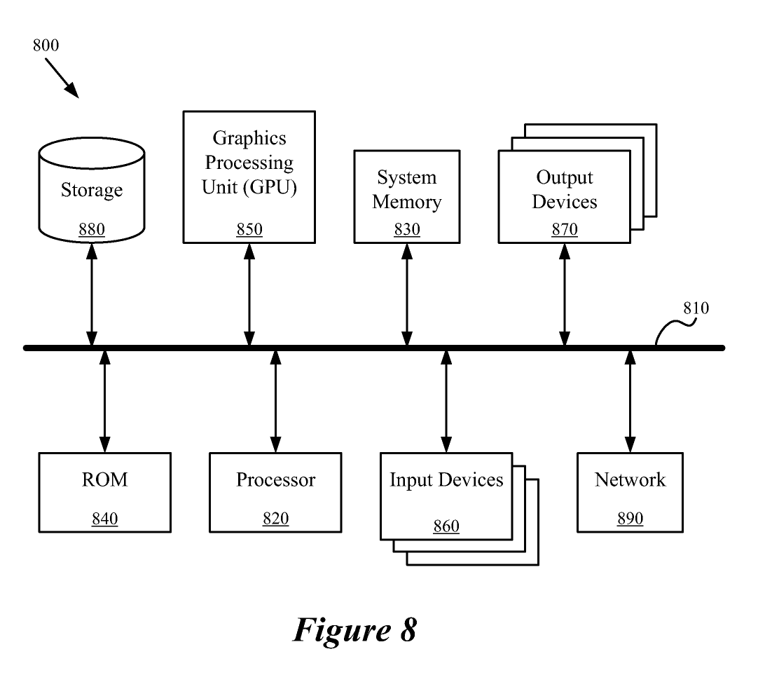

FIG. 8 illustrates a schematic block diagram of a computer system 800 with which some embodiments of the disclosure may be implemented. For example, the system described above in reference to FIG. 1 may be at least partially implemented using computer system 800. As another example, the processes described in reference to FIG. 2 and FIG. 4 may be at least partially implemented using sets of instructions that are executed using computer system 800.

Computer system 800 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 800 may include a bus 810, at least one processing element 820, a system memory 830, a read-only memory (“ROM”) 840, other components (e.g., a graphics processing unit) 850, input devices 860, output devices 870, permanent storage devices 880, and/or a network connection 890. The components of computer system 800 may be electronic devices that automatically perform operations based on digital and/or analog input signals.

Bus 810 represents all communication pathways among the elements of computer system 800. Such pathways may include wired, wireless, optical, and/or other appropriate communication pathways. For example, input devices 860 and/or output devices 870 may be coupled to the system 800 using a wireless connection protocol or system. The processor 820 may, in order to execute the processes of some embodiments, retrieve instructions to execute and data to process from components such as system memory 830, ROM 840, and permanent storage device 880. Such instructions and data may be passed over bus 810.

ROM 840 may store static data and instructions that may be used by processor 820 and/or other elements of the computer system. Permanent storage device 880 may be a read-and-write memory device. This device may be a non-volatile memory unit that stores instructions and data even when computer system 800 is off or unpowered. Permanent storage device 110 may include a mass-storage device (such as a magnetic or optical disk and its corresponding disk drive).

Computer system 800 may use a removable storage device and/or a destination storage device as the permanent storage device. System memory 830 may be a volatile read-and-write memory, such as a random access memory (“RAM”). The system memory may store some of the instructions and data that the processor uses at runtime. The sets of instructions and/or data used to implement some embodiments may be stored in the system memory 830, the permanent storage device 880, and/or the read-only memory 840. For example, the various memory units may include instructions for authenticating a client-side application at the server-side application in accordance with some embodiments. Other components 850 may perform various other functions. These functions may include interfacing with various communication devices, systems, and/or protocols.

Input devices 860 may enable a user to communicate information to the computer system and/or manipulate various operations of the system. The input devices may include keyboards, cursor control devices, audio input devices and/or video input devices. Output devices 870 may include printers, displays, and/or audio devices. Some or all of the input and/or output devices may be wirelessly or optically connected to the computer system.

Finally, as shown in FIG. 8, computer system 800 may be coupled to a network through a network adapter 890. For example, computer system 800 may be coupled to a web server on the Internet such that a web browser executing on computer system 800 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 800 may be used in conjunction with the disclosed embodiments. Moreover, one of ordinary skill in the art will appreciate that many other system configurations may also be used in conjunction with the disclosed embodiments or components of the embodiments.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the disclosure has been described with reference to numerous specific details, one of ordinary skill in the art will recognize that the disclosure can be embodied in other specific forms without departing from the scope of the disclosure. For example, several embodiments were described above by reference to particular features and/or components. However, one of ordinary skill in the art will realize that other embodiments might be implemented with other types of features and components, and that the disclosure is not to be limited by the foregoing illustrative details.

What is claimed is:

1. A method for creating a location scouting tool comprising:
receiving content (205);
receiving a geographical identification of a location (220) used in creating the content;
determining that the identification of the location complies with access rules (225) assigned to a content contributor;
receiving location information from the content contributor (245);
associating the location and the location information to the content as a location annotation (250); and
providing a location scouting engine (635) for returning detailed location information gathered from a plurality of location annotations.

2. The method of claim 1, wherein the set of access rules determines user access for associating location annotations to the content.

3. The method of claim 1, wherein the location scouting engine further comprises a location rating generator for calculating a location rating based on the location information.

4. The method of claim 1, wherein the location scouting engine further comprises a location aggregator for aggregating a plurality of location annotations into a location information view (365).

5. The method of claim 1, wherein the location information includes a location type and one or more scene descriptions.

6. The method of claim 1, wherein the location information includes rating for shootability, accessibility, and crew conveniences.

7. The method of claim 1, wherein the location information includes location contact information and permit requirements for producing content at the location.

8. An apparatus for creating a location scouting tool comprising:
a storage (880) for storing content, a set of content creators corresponding to the content, and a set of location associated with the content;
a memory (830) for storing sets of instructions;
a processor (820) for executing the sets of instructions, wherein the processor:
defines a set of access rules for each content creator, wherein the access rules limit annotation rights of the content creators;
evaluates whether location annotations received from the content creators are in compliance with the set of access rules;
allows location annotations to be stored in the storage if the annotations are in compliance with the set of access rules; and
generates a location information interface that includes an aggregation of location annotations and associated location information.

9. The apparatus of claim 8, wherein the memory further comprises sets of instructions for defining access rules based on at least one of the content creator's contribution to the content and the content creator's role in the creation of the content.

10. The apparatus of claim 8, wherein the memory further comprises sets of instructions for defining a location rating based on location information provided in the location annotations.

11. The apparatus of claim 8, wherein the memory further comprises sets of instructions for defining access rules to limit on the number of location annotations allowed by the content creator for the content.

12. The apparatus of claim 8, wherein the memory further comprises sets of instructions for defining a location scouting search engine for returning location scouting information provided by a plurality of content creators.

13. The apparatus of claim 8 further comprising a network connection for transmitting content and annotations to the storage.

14. A non-transitory computer readable medium storing a repository application for execution by at least one processor, the repository application comprising sets of instructions for:
defining a video player (610, 720), wherein the video player comprises controls for creating annotations to content being viewed in the video player;
defining a user management module (655, 730) for managing different categories of content creators;
defining an access rules module (625, 740) for limiting annotation rights made using the video player;
defining an annotation module (615, 750) for creating annotations in association with the content; and
defining a location scouting engine (635, 760) for parsing location annotations provided by content creators.

15. The non-transitory computer readable storage medium of claim 14, wherein the location scouting engine further comprises a location aggregator for aggregating location information from a plurality of location annotations.

16. The non-transitory computer readable storage medium of claim 14, wherein the location scouting engine further comprises a location rating generator for calculating a location rating based on a content creator feedback.

17. The non-transitory computer readable storage medium of claim 15, wherein the location rating generator combines rating for shootability, accessibility, and crew conveniences to calculate a location rating.

18. The non-transitory computer readable storage medium of claim 14, wherein the access rules module establishes rules for limiting the number of location annotations provided by a content creator for a particular piece of content.

19. The non-transitory computer readable storage medium of claim 14, wherein the access rules module establishes rules for limiting location annotation creation by content creators identified as location managers during content creation.

20. The non-transitory computer readable storage medium of claim 14, wherein the location scouting engine aggregates a plurality of projects having a common location.
